(19) United States
(12) Patent Application Publication
(10) Pub. No.: US 2026/0341658 A1
(43) Pub. Date: Oct. 29, 2026

(54) ADVANCED METAL STRIP IONIZATION CHAMBER

(71) Applicant: Central China Normal University, Wuhan (CN)

(72) Inventors: Chaosong Gao, Wuhan (CN); Jingyun Feng, Wuhan (CN); Zhike Feng, Wuhan (CN)

(21) Appl. No.: 19/360,902

(22) Filed: Oct. 16, 2025

(30) Foreign Application Priority Data
Apr. 25, 2025 (CN) 202510527476.9

(51) Int. Cl. H01J 47/04

(52) U.S. Cl. CPC H01J 47/04

(57) ABSTRACT

An advanced metal strip ionization chamber includes two pairs of anode plates and two pairs of cathode plates. The anode plates are fabricated using a complementary metal-oxide-semiconductor (CMOS) process, with a plurality of metal strip electrodes integrated on an exposed top-level metal layer, and are integrated with readout electronics on a same chip. According to the present disclosure, the CMOS process is employed to integrate charge-collecting electrodes (i.e., metal strips) and readout circuits on a single chip. Superior spatial resolution is achieved compared with traditional ionization chambers. Furthermore, the need for wire bonding is eliminated, significantly reducing system integration complexity.

### CROSS-REFERENCE TO RELATED APPLICATION

This application claims priority of Chinese Patent Application No. 202510527476.9, filed on Apr. 25, 2025, the entire contents of which are incorporated herein by reference.

### TECHNICAL FIELD

The present disclosure belongs to the technical field of beam position monitoring, and specifically to an advanced metal strip ionization chamber.

### BACKGROUND

Ionization chambers are commonly employed for beam position and transverse profile monitoring. The ionization chambers interact with beams to generate weak current signals. These signals are collected by charge-collecting electrodes and are amplified, acquired, and processed by readout circuits to obtain beam position and transverse profile information, thereby improving beam control precision.

An ionization chamber generally includes two parallel plates, which serve as an anode plate and a cathode plate, respectively. A gap between the two parallel plates is typically several millimeters wide and is filled with gas, which acts as an ionization region. In conventional ionization chambers, the anode plates are fabricated using printed circuit board (PCB) technology to form strip or pixel electrodes, with electrode signals being read out and processed by a multi-channel application-specific integrated circuit (ASIC).

The conventional ionization chambers suffer from the following limitations. 1. Constrained by PCB technology, the conventional ionization chambers have a relatively low positional resolution, typically greater than 100 µm. 2. The charge-collecting electrodes and readout chips are separated and require wire bonding, which significantly increases system integration complexity.

### SUMMARY

To solve the above problems, an objective of the present disclosure is to provide an advanced metal strip ionization chamber.

To realize the above objective, the present disclosure employs the following technical solutions: an advanced metal strip ionization chamber includes two pairs of anode plates and two pairs of cathode plates. The anode plates are fabricated using a complementary metal-oxide-semiconductor (CMOS) process, with a plurality of metal strip electrodes integrated on an exposed top-level metal layer, and are integrated with readout electronics on a same chip, called MStrip.

In a further description of the above technical solution:

MStrip chips are adopted, serving as electrodes of the anode plates and as charge readout chips.

In a further description of the above technical solution:

The metal strip electrodes offer micrometer-scale positional resolution.

In a further description of the above technical solution:

The metal strip electrodes and the readout electronics are directly connected inside the chip.

In conclusion, by adopting the above technical solutions, the present disclosure has the following beneficial effects.

In the present disclosure, the CMOS process is employed to integrate charge-collecting electrodes (i.e., metal strips) and readout circuits on a single chip. Superior spatial resolution is achieved compared with traditional ionization chambers. Furthermore, the need for wire bonding is eliminated, thereby significantly reducing system integration complexity.

### BRIEF DESCRIPTION OF THE DRAWINGS

FIG. 1 is a schematic overall structural diagram of an advanced metal strip ionization chamber.

FIG. 2 is an exploded view of the advanced metal strip ionization chamber.

### REFERENCE NUMERALS AND DENOTATIONS THEREOF

1-anode plate; 11-metal strip electrode; 12-readout electronics; 13-chip; and 2-cathode plate.

### DETAILED DESCRIPTION

The technical solutions in the embodiments of the present disclosure are described below clearly and completely with reference to the accompanying drawings. Obviously, the described embodiments are merely some, but not all, of the embodiments of the present disclosure. Based on the embodiments of the present disclosure, all other embodiments obtained by those ordinary skilled in the art without creative efforts fall within the scope of protection of the present disclosure.

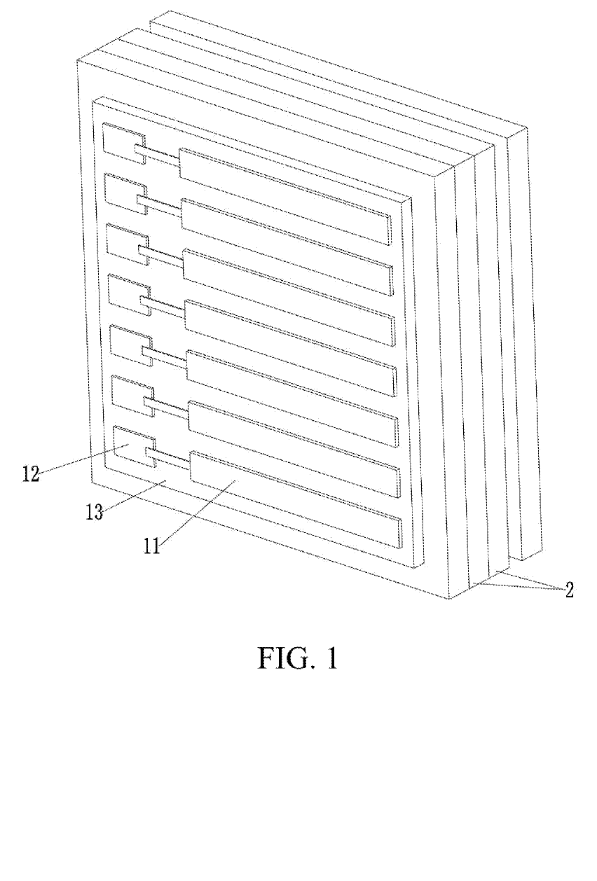

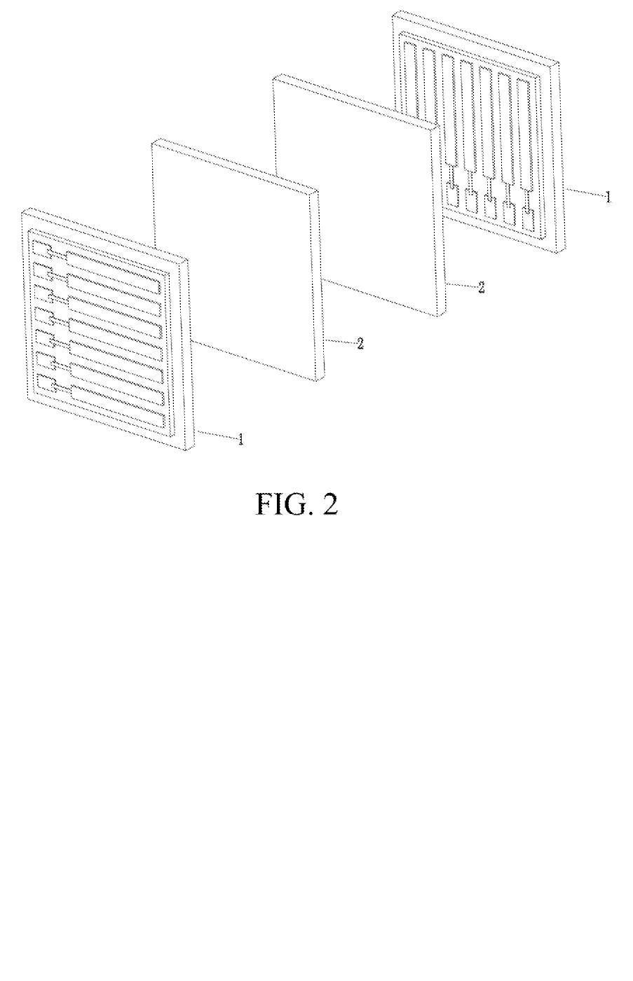

Referring to FIGS. 1-2, the present disclosure provides a technical solution. An advanced metal strip ionization chamber includes two pairs of anode plates 1 and two pairs of cathode plates 2. The anode plates 1 are fabricated using a CMOS process, with a plurality of metal strip electrodes 11 integrated on an exposed top-level metal layer, and are integrated with readout electronics 12 on a same chip 13.

MStrip chips are adopted, serving as electrodes of the anode plates 1 and as charge readout chips.

The metal strip electrodes 11 offer micrometer-scale positional resolution.

The metal strip electrodes 11 and the readout electronics 12 are directly connected inside the chip 1, avoiding additional input capacitance introduced by packaging solder and its pins, thereby facilitating the low-noise and high-speed performance of the readout electronics 12 while reducing system complexity.

The CMOS process is employed to integrate charge-collecting electrodes (i.e., metal strips) and readout circuits on a single chip. Superior spatial resolution is achieved compared with traditional ionization chambers. Furthermore, the need for wire bonding is eliminated, thereby significantly reducing system integration complexity.

The foregoing descriptions are only the preferred embodiments of the present disclosure and are not to be construed as limiting the scope thereof. Any equivalent substitutions or modifications made by those skilled in the art, within the technical scope disclosed in the present disclosure, based on its technical solutions and inventive concepts, fall within the scope of protection of the present disclosure.

1. An advanced metal strip ionization chamber, comprising: two pairs of anode plates (1) and two pairs of cathode plates (2), wherein the anode plates (1) are fabricated using a complementary metal-oxide-semiconductor (CMOS) process, with a plurality of metal strip electrodes (11) integrated on an exposed top-level metal layer, and are integrated with readout electronics (12) on a same chip.

2. The advanced metal strip ionization chamber according to claim 1, wherein MStrip chips are adopted, serving as electrodes of the anode plates (1) and as charge readout chips.

3. The advanced metal strip ionization chamber according to claim 1, wherein the metal strip electrodes (11) offer micrometer-scale positional resolution.

4. The advanced metal strip ionization chamber according to claim 1, wherein the metal strip electrodes (11) and the readout electronics (12) are directly connected inside the chip.
